(19) United States
(12) Patent Application Publication
(10) Pub. No.: US 2014/0092022 A1
(43) Pub. Date: Apr. 3, 2014

(54) LIGHT EMITTING KEYBOARD

(71) Applicant: DUCKYCHANNEL INTERNATIONAL CO., LTD., Taipei City (TW)

(72) Inventor: Shih-Chuan Chao, Taipei City (TW)

(73) Assignee: Duckychannel International Co., Ltd., Taipei City (TW)

(21) Appl. No.: 13/846,008

(22) Filed: Mar. 18, 2013

(30) Foreign Application Priority Data
Sep. 28, 2012 (TW) 101218804

(51) Int. Cl. G06F 3/02

(52) U.S. Cl. CPC G06F 3/02
USPC 345/170

(57) ABSTRACT

A light emitting keyboard is provided. The keyboard includes: a plurality of keys, wherein each of the keys has a light source; and a controller, for controlling the light sources of a plurality of designated keys to be turned on or off.

### CROSS REFERENCE TO RELATED APPLICATIONS

This Non-provisional application claims priority under 35 U.S.C. §119(a) on Patent Application No(s). 101,218,804, filed in Taiwan, Republic of China on Sep. 28, 2012, the entire contents of which are hereby incorporated by reference.

### BACKGROUND OF THE INVENTION

1. Field of the Invention

The present invention relates to keyboard emitting technology.

2. Description of the Related Art

In order to conform with the habits of most people, the keyboards available are usually designed in accordance with the QWERTY keyboard standard. To achieve more uses such as for game playing, some of the keyboards allow players to define each key for a specific instruction. As such, undefined keys will not be a problem when playing games and players can efficiently manipulate the keys for games. However, the user-defined keys on the keyboards in the prior art lack any eye-catching labeling, so that inexperienced users can not easily find them, which reduces the efficiency during keyboard operations.

### BRIEF SUMMARY OF THE INVENTION

The present invention provides a light emitting keyboard. The keyboard comprises: a plurality of keys, wherein each of the keys has a light source; and a controller, for controlling the light sources of a plurality of designated keys to be turned on or off.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIGS. 1A and 1B is a schematic diagram of a light emitting keyboard according to an embodiment of the present invention.

FIG. 2 is a schematic diagram of a light emitting keyboard according to an embodiment of the present invention.

FIG. 3 is a schematic diagram of a light emitting keyboard according to an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The present invention provides a specific keyboard to overcome the defects on the keyboards in the prior art.

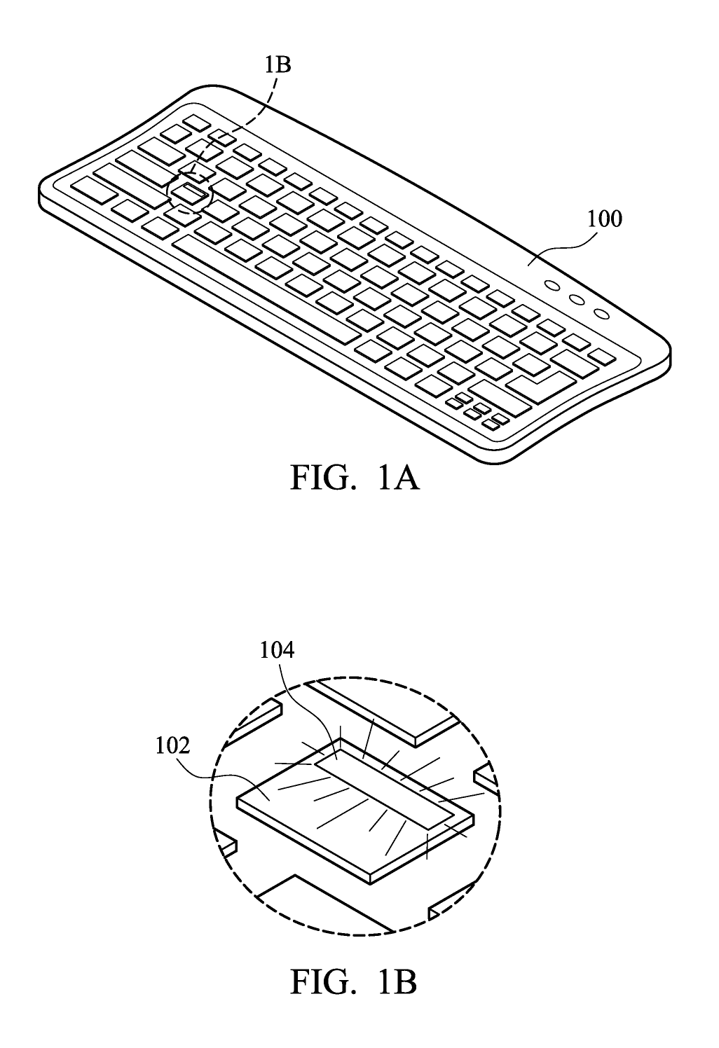

FIGS. 1A and 1B is a schematic diagram of a light emitting keyboard according to an embodiment of the present invention. The light emitting keyboard 100 has a plurality of keys 102, and each key 102 has a light source 104 which can be respectively turned on and off. As shown in FIGS. 1A and 1B, the light source 104 of the key is a light emitting diode (LED) located in the housing of the key 102. When the light source 104 is turned on, a light can be emitted through any area on the key 102 that is pervious by light. The light-pervious area can be located on various places and have various sizes and appearances, and should not be limited to those of the embodiments in FIGS. 1A and 1B. The keyboard of the present invention can emit light, and therefore is particularly suitable for use in dim environments.

Note that the light emitting keyboard 100 of the present invention has a unique controller embedded in the keyboard 100 (not shown in Figs.). The controller can turn on and off the light source of the designated key(s). Specifically, for easy identification, the controller can turn on the light source of the keys which are defined by a user and turn off the light source of the keys which are not defined by the user. The following embodiment describes how the keyboard of the present invention controls the light source.

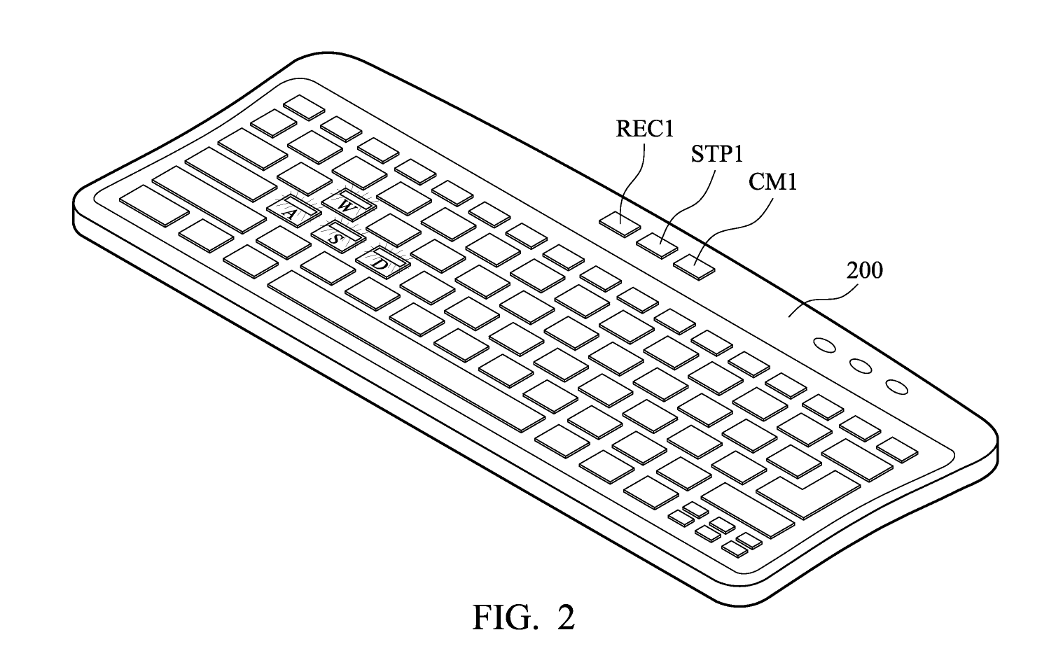

FIG. 2 is a schematic diagram of a light emitting keyboard according to an embodiment of the present invention. In an embodiment, the keyboard 200 of the present invention further comprises a record key REC1, a pause key STP1 and a play key CM1. In detail, when the user presses the record key REC1, the controller starts the recording process for recording the keys pressed by the user (for example, the key A, S, D and W in this embodiment). Then, the controller stops the recording process when the user presses the pause key STP1. Note that the record key REC1 and pause key STP1 are merely for illustration, and, in a better embodiment, the pause key STP1 can be replaced by another key such as the record key REC1 (for example, pressing the record key REC1 after the start of the recording process means to stop the recording process). The play key CM1 in this embodiment corresponds to the record key REC1. When the user presses the play key CM1, the controller turns on the light sources of the keys A, S, D and W and turns off the others. As such, users can easily find the defined keys, thus improving operational efficiency.

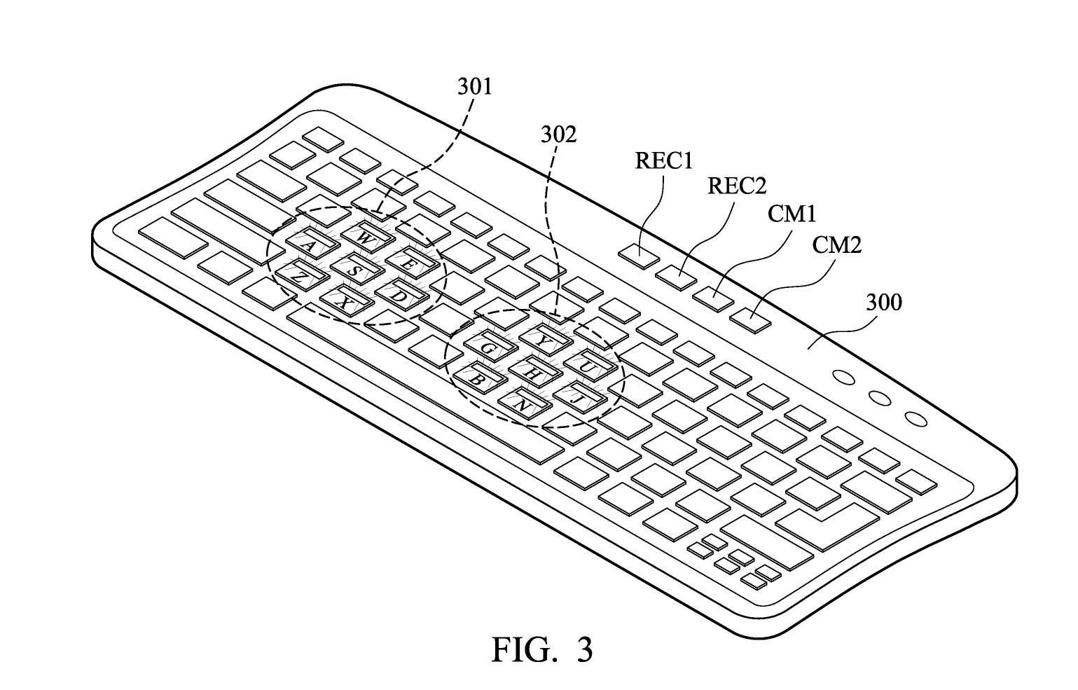

In some embodiments, there may be several groups of recorded keys. FIG. 3 is a schematic diagram of a light emitting keyboard according to an embodiment of the present invention. As shown in FIG. 3, in addition to the set including the record key REC1 (also serves as the pause key) and the play key CM1, the keyboard 300 of the present invention further has another set that includes a record key REC2 (also serves as the pause key) and a play key CM2, where the two sets represent two groups of the self-defined keys 301 and 302. The light sources of the key groups 301 and 302 are respectively turned on and off according to the configuration of the play keys CM1 and CM2. Specifically, when the play keys CM1 and CM2 are both pressed, the key groups 301 and 302 are both turned on as shown in FIG. 3. In some embodiments, in order to distinguish between different key groups, the light source of the keys in different groups can be turned on with different colors or luminance. Two key groups in this embodiment are merely for illustration, and those skilled in the art can design a keyboard for recording more key groups by referring to this embodiment.

Noted that although the recording and playing in the embodiments described above are implemented through hardware, the present invention should not be limited thereto. In some embodiments, they can also be implemented through software. Specifically, the controller of the present invention can control the light source of the designated keys according to the setting values from a certain application installed in the computer which is connected to the keyboard.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A light emitting keyboard, comprising:
a plurality of keys, wherein each of the keys has a light source; and
a controller, for controlling the light sources of a plurality of designated keys to be turned on or off.

2. The light emitting keyboard as claimed in claim 1, further comprising:
at least one play key,
wherein the controller turns on the light sources of the designated keys when the play key is pressed.

3. The light emitting keyboard as claimed in claim 1, further comprising:
at least one record key,
wherein when the record key is pressed, the controller records the keys that are pressed after the record key, wherein the designated keys are the keys recorded.

4. The light emitting keyboard as claimed in claim 3, further comprising:
a pause key,
wherein the controller pauses recording the keys when the pause key is pressed.

5. The light emitting keyboard as claimed in claim 3, wherein the controller stops recording the keys when the record key is pressed again.

6. The light emitting keyboard as claimed in claim 1, wherein the controller controls the light sources of the designated keys to be turned on or off according to the setting value.
